(19) United States
(12) Patent Application Publication
(10) Pub. No.: US 2023/0063329 A1
(43) Pub. Date: Mar. 2, 2023

(54) MODULAR MIRROR SUBSYSTEMS FOR MULTI-SIDE SCANNING

(71) Applicant: Cognex Corporation, Natick, MA (US)

(72) Inventors: Saul Sanz Rodriguez, Aachen (DE); Tony Depre, Kohlscheid (DE); Jens Ruetten, Aachen (DE); Laurens Nunnink, Simpelveld (NL)

(21) Appl. No.: 17/894,848

(22) Filed: Aug. 24, 2022

Related U.S. Application Data
(60) Provisional application No. 63/236,560, filed on Aug. 24, 2021.

(51) Int. Cl. H04N 5/225; G02B 7/182; G02B 26/10; H04N 5/247; G06K 7/14

(52) U.S. Cl. CPC H04N 5/2253; G02B 7/1821; G02B 26/105; H04N 5/2256; H04N 5/247; G06K 7/1413

(57) ABSTRACT

A method for an imaging module can include rotating an imaging assembly that includes an imaging device about a first pivot point of a bracket to a select first orientation, fastening the imaging assembly to the bracket at the first orientation, rotating a mirror assembly that includes a mirror about a second pivot point of the bracket to a select second orientation, and fastening the mirror assembly to the bracket at the second orientation. An adjustable, selectively oriented imaging assembly of a first imaging module can acquire images using an adjustable, selectively oriented mirror assembly of a second imaging module.

### CROSS-REFERENCE TO RELATED APPLICATIONS

The present application claims priority to request for patent application number 2116280.5, filed on Nov. 11, 2021, the disclosure of which is hereby incorporated in its entirety at least by reference.

### BACKGROUND OF THE INVENTION

### 1. Field of the Invention

The present invention relates generally to shelving and showcase racks but more particularly to a card cases showcase stand and method of assembly.

### 2. Description of Related Art

Stores need efficient shelving systems for optimal use of their space, secure stocking of items, and convenience for clients. Besides that, it helps the sales if the products are placed for best visibility, hence the concept of showcase shelves or stands.

Because each product is different, there is a need for many different configurations, each being optimized in order to best showcase a given product. There are many inventions in the field, for example, U.S. Pat. Nos. 1,609,945, 1,881,986 and 5,289,926 describe a display support which has a cardboard structure which is of the fold and assemble type. The support has horizontal shelves which can be tilted so as to receive goods.

U.S. Pat. No. 2,368,909 describes a display stand that includes two side uprights that are equipped with side fasteners, and clips support angled horizontal shelves that are assembled to each other.

U.S. Pat. No. 3,079,003 describes a support for containers which receives small parts. The support notably includes two uprights triangular laterals which are assembled with perpendicular central rods which are inserted into slots. The rods are equipped with side extensions used for holding containers.

U.S. Pat. No. 4,938,365 describes a support for documents of literature. The support notably includes side uprights which are assembled to each other by means of extensions which are inserted inside slots. An integrated opening provides support for documents.

US patent 20040074855 describes a shelf support device which includes two side uprights which have shelves with slots are inserted into the extensions of the side uprights.

US patent application 20080277363 describes a support which has two side uprights which receive horizontal shelves. The components are notably assembled by means of lateral pins.

French patent FR2747549 describes a support which consists of two side vertical uprights which are provided with slots. The slots receive perpendicular rods. The rods support a flexible canvas.

Because of the fact that new products come out all the time and that cards are collectors items which can go up in value, there is a need to provide a special casing to protect the card, and that casing requires a special display stand that can hold and display the cards properly, this creates a need for developing new shelving and showcase racks.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present disclosure to provide for a card cases showcase stand and method of assembly.

In order to do so, the present invention provides for a card cases showcase stand having a pair of support legs onto which are connected a plurality of card racks, each card rack having two side by side cavities, separated by a partition, and each cavity configured and sized for receiving a card enclosure.

The support legs having a base portion configured for resting on a horizontal surface, and an angled portion extending integrally and angularly therefrom so as to create a generally “V” shaped form from which extends integrally and vertically a plurality of receiving members so that they are perpendicular relative to the base portion.

In a preferred embodiment, the card cases showcase has the angled portion having a sawtooth configuration.

In another preferred embodiment, the card racks are inserted and pushed down through pegs by passing through pocket receptacles located at the back of the card racks until they touch the angled portion of the leg members.

In yet another preferred embodiment, the card racks are inserted and pushed down through doublet resiliently deformable pins by passing through pocket receptacles located at the back of the card racks until they touch the angled portion of the leg members.

The card cases showcase stand of claim 1 has a method of assembly that consists in the steps of:

a) insetting the lowermost card rack into the receiving members of the two support legs;

b) inserting the uppermost card rack into the receiving members of the two support legs;

c) inserting more card racks between the lowermost and the uppermost card racks so as to a desired number of card racks.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 Exploded view of an embodiment of the invention.

FIG. 2 Isometric view of the invention.

FIG. 3 Isometric view of the invention with card enclosures.

FIG. 4 Side view of the invention with card enclosures.

FIG. 5A Side view of the invention with an alternate embodiment of the pins.

FIG. 5B Side view detail of the alternate embodiment of FIG. 5A.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein.

It is to be understood that the terminology used herein is for the purpose of describing particular embodiments only and is not intended to be limiting. The terms “a” or “an,” as used herein, are defined as to mean “at least one”. The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about”, “generally”, or “approximately” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

Referring now to any of the accompanying FIGURES, according to a first embodiment, there is provided a card cases showcase rack (10) comprising a pair of support legs (12) onto which are connected a plurality of card racks (14), each having two side by side cavities (26), separated by a partition (27), and each cavity (26) configured and sized for receiving a card enclosure (28).

The support legs (12) have a base portion (16) that rests on a horizontal surface such as a table or counter, and an angled portion (18) extending integrally and angularly so as to create a generally “V” shaped form. The angled portion (18) has a sawtooth configuration (19) from which extends integrally and vertically a plurality of receiving members (20).

in the form of pegs or doubled pins extending integrally from the support legs. (20) so that they are perpendicular to the base portion (16).

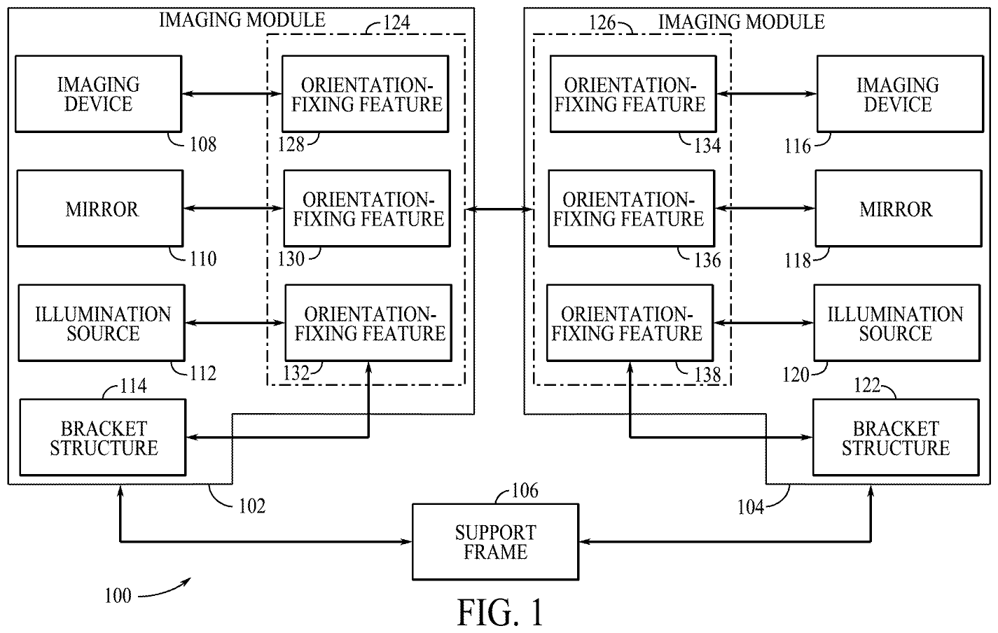

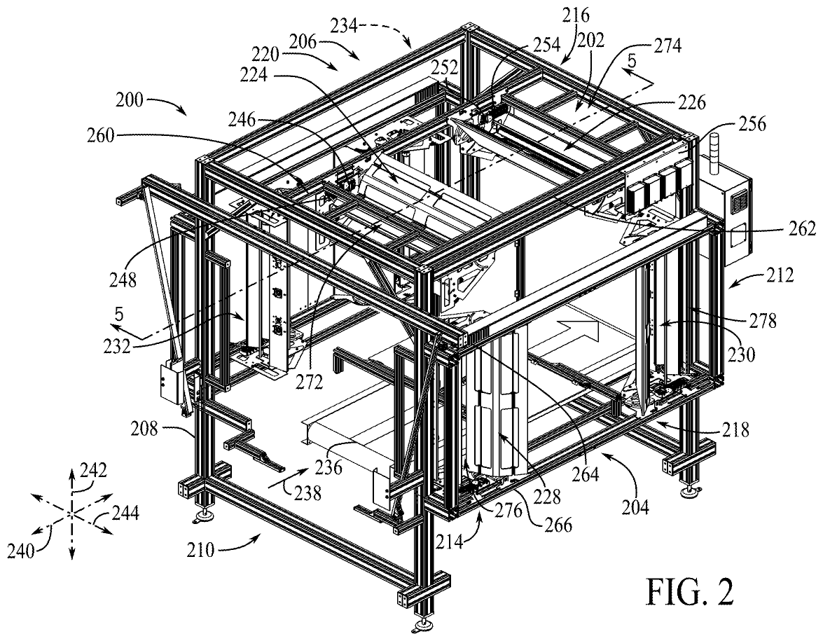

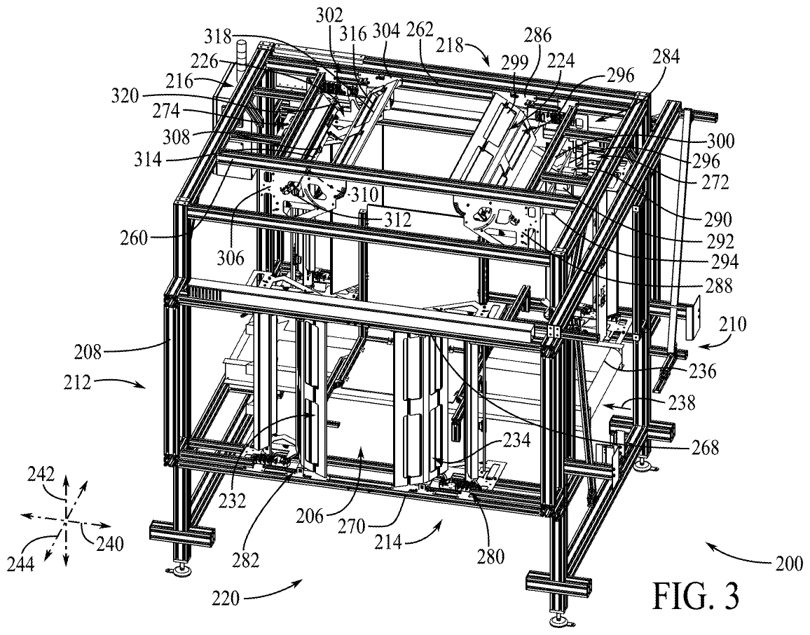

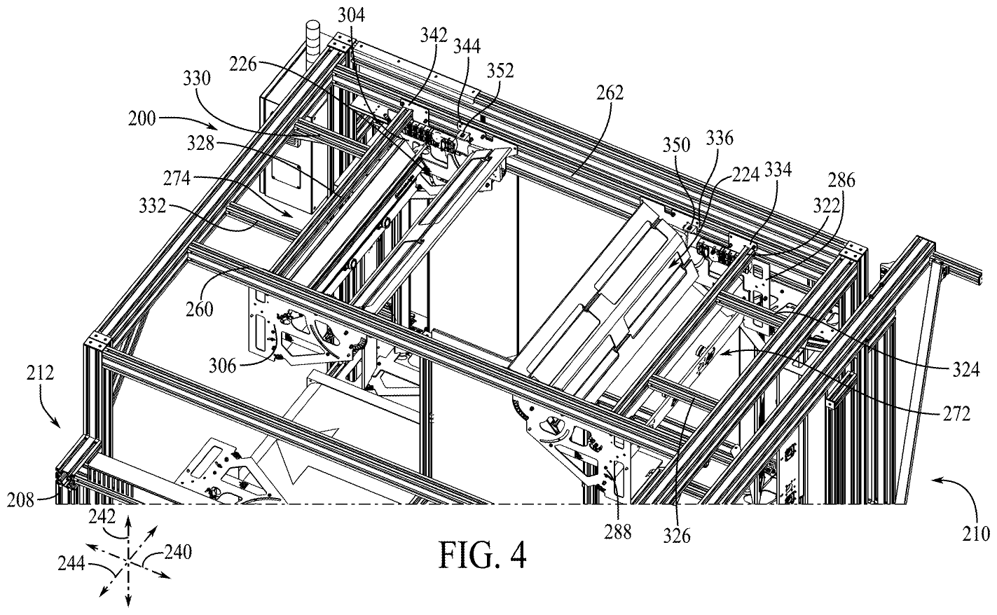

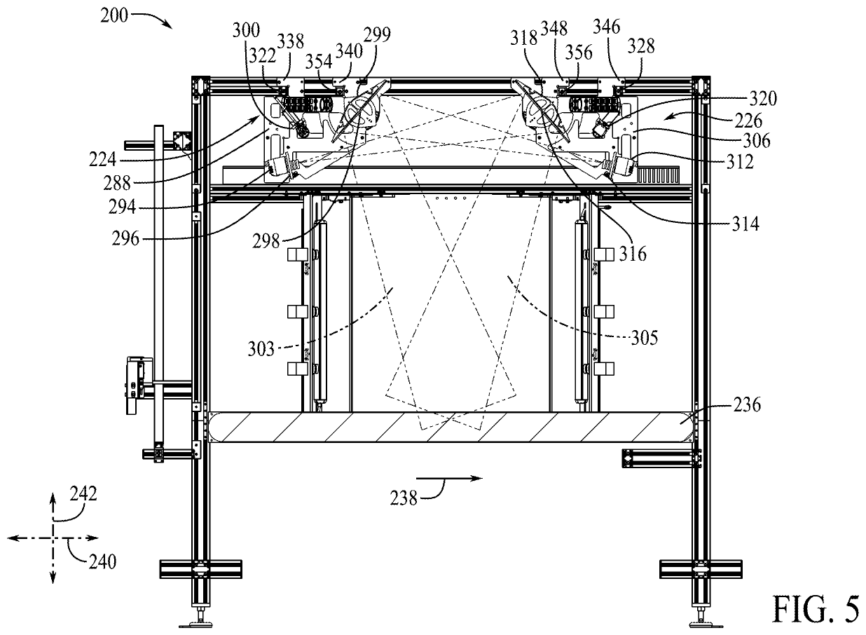

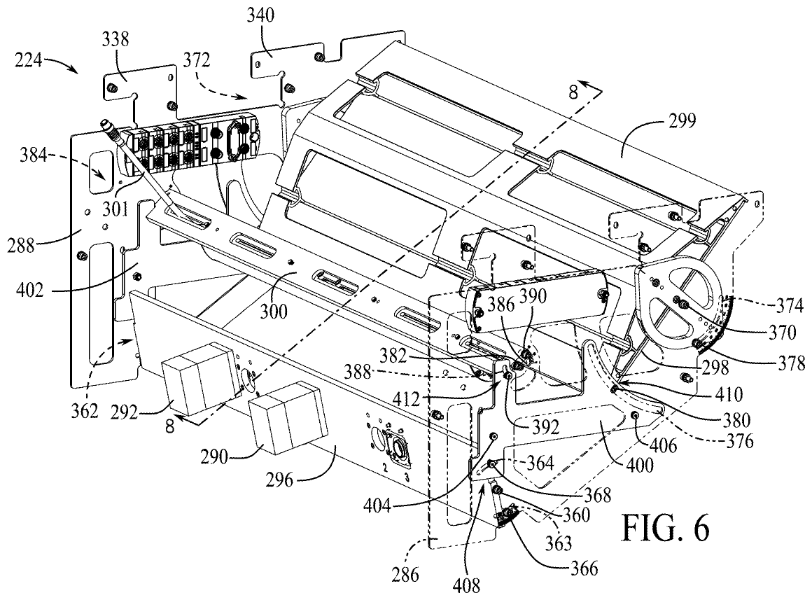

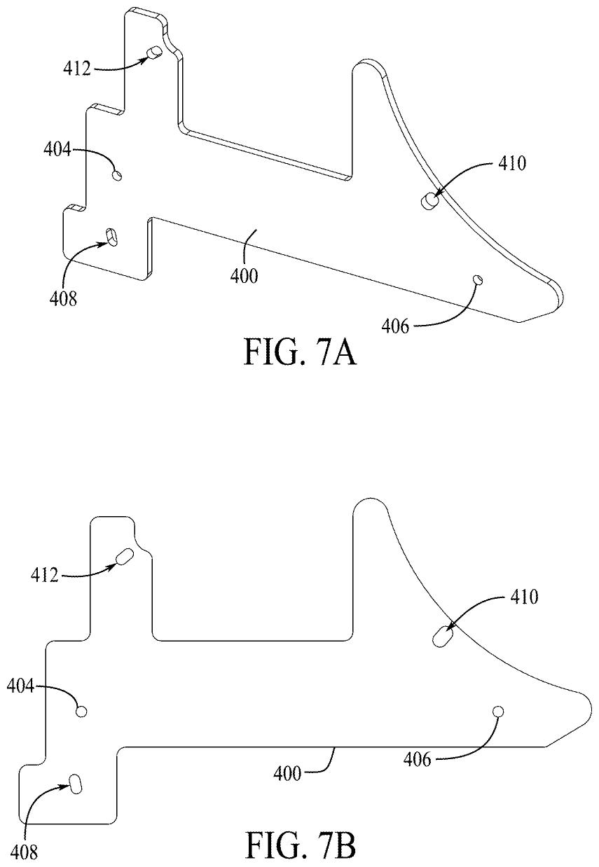

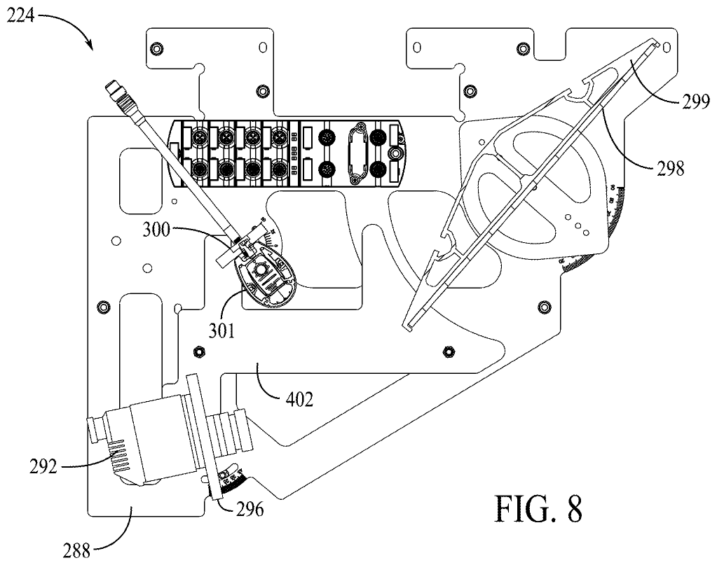

As best seen in FIGS. 1 and 4, the receiving members (20) come in the guise of pegs (21), whereas, as best seen in FIGS. 5A-B, the receiving members (20) come in the guise of doublet resiliently deformable pins (22).

Card racks (14) are inserted and pushed down through receiving members (20) by passing through pocket receptacles (24) located at the back of the card racks (14) until they touch the sawtooth configuration (19).

As best seen id FIGS. 5AB, there is an alternate way for connecting the card racks (14) onto the support legs (12) in which the card racks (14) are inserted and pushed down through doublet resiliently deformable pins (22) by passing through the pocket receptacles (24) located at the back of the card racks (14) until they touch the sawtooth configuration (19).

The resiliently deformable pins (22) have tabs (23) that prevent the pulling out of the card racks (14) unless the resiliently deformable pins (22) are pushed towards each other so that the card rack (14) can pass through when pulled upwardly.

The showcase rack (10) generally comes in a non-assembled configuration, which means that assembly is required.

The method of assembly consists in the steps of:

a) inserting the lowermost card rack (14) into the receiving members (20) of the two support legs (12);

b) inserting the uppermost card rack (14) into the receiving members (20) of the two support legs (12);

c) inserting more card racks between the lowermost and the uppermost card racks (14) so as to occupy all receiving members (20), or to install a desired number of card racks (20).

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. An imaging system for use with a support frame, the imaging system comprising:
an imaging module configured to be coupled to the support frame, the imaging module including:
a bracket structure that includes a first bracket and a second bracket;
a mirror assembly including a mirror, the mirror assembly being rotatably coupled to the bracket structure and rotatably adjustable to a plurality of mirror angles relative to the bracket structure, the mirror assembly being positioned between the first and second brackets;
an imaging assembly including an imaging device, the imaging assembly being rotatably coupled to the bracket structure and rotatably adjustable to a plurality of imaging-device angles relative to the bracket structure, the imaging assembly being positioned between the first and second brackets; and
a guide plate that is configured to be coupled to the bracket structure, and
when the guide plate is coupled to the bracket structure, the guide plate constrains at least one of:
the mirror assembly to be oriented at a first predetermined mirror angle of the plurality of mirror angles when the mirror assembly is coupled to the bracket structure; or
the imaging assembly to be orientated at a first predetermined imaging-device angle of the plurality of imaging-device angles.

2. The imaging system of claim 1, wherein when the guide plate is coupled to the bracket structure, the guide plate constrains:
the mirror assembly to be oriented at the first predetermined mirror angle of the plurality of mirror angles when the mirror assembly is coupled to the bracket structure; and
the imaging assembly to be orientated at the first predetermined imaging-device angle of the plurality of imaging-device angles when the imaging assembly is coupled to the bracket structure.

3. The imaging system of claim 2, wherein the guide plate includes a first orientation-fixing feature and a second orientation-fixing feature, and
wherein the first orientation-fixing feature is configured to secure the mirror assembly relative to the bracket structure at the first predetermined mirror angle, and
wherein the second orientation-fixing feature is configured to secure the imaging assembly relative to the bracket structure at the first predetermined imaging-device angle.

4. The imaging system of claim 3, further comprising:
a second guide plate that is configured to be coupled to a second bracket structure of a second imaging module, and
wherein the second guide plate includes at least one of the first orientation-fixing feature, or the second orientation-fixing feature.

5. The imaging system of claim 3, wherein the first bracket includes a first slot and a second slot, and
wherein the first orientation-fixing feature includes a first hole through the guide plate, and a first fastener is configured to be received through the first slot and the first hole, and engaged with the mirror assembly to orient the mirror assembly at the first predetermined mirror angle, and
wherein the second orientation-fixing feature includes a second hole directed through the guide plate, and a second faster being received through the second slot, the second hole, and engaged with the imaging assembly to orient the imaging assembly at the first predetermined imaging-device angle.

6. The imaging system of claim 2, wherein the guide plate is a first guide plate that is configured to be coupled to the first bracket, and further comprising a second guide plate that is configured to be coupled to the second bracket, and
wherein when the second guide plate is coupled to the second bracket, the second guide plate further constrains:
the mirror assembly to be oriented at the first predetermined mirror angle of the plurality of mirror angles when the mirror assembly is coupled to the bracket structure; and
the imaging assembly to be orientated at the first predetermined imaging-device angle of the plurality of imaging-device angles when the imaging assembly is coupled to the bracket structure.

7. The imaging system of claim 2, wherein the first predetermined imaging-device angle corresponds to a predetermined working distance and a predetermined perspective for the imaging device.

8. The imaging device of claim 2, wherein the imaging module includes an illumination assembly including an illumination source, the illumination assembly being pivotally coupled to the bracket structure and rotatably adjustable to a plurality of illumination-source angles relative to the bracket structure, the illumination assembly being positioned between the first and second brackets, and
wherein, when the guide plate is coupled to the bracket structure, the guide plate constrains the illumination assembly to be oriented at a first predetermined illumination-source angle of the plurality of illumination source angles when the illumination assembly is coupled to the bracket structure.

9. The imaging system of claim 2, wherein the guide plate is a first guide plate that is configured to be coupled to the bracket structure at a first location, the imaging system further comprising a second guide plate configured to be coupled to the bracket structure at the first location, in place of the first guide plate, so that, when the second guide plate is coupled to the bracket structure, the second guide plate constrains:
the mirror assembly to be oriented at a second predetermined mirror angle of the plurality of mirror angles when the mirror assembly is coupled to the bracket structure; or
the imaging assembly to be orientated at a second predetermined imaging-device angle of the plurality of imaging-device angles when the imaging assembly is coupled to the bracket structure.

10. The imaging system of claim 9, wherein when the second guide plate is coupled to the bracket structure, the second guide plate constrains one or more of:
the mirror assembly to be oriented at the second predetermined mirror angle of the plurality of mirror angles when the mirror assembly is coupled to the bracket structure; or
the imaging assembly to be orientated at the second predetermined imaging-device angle of the plurality of imaging-device angles when the imaging assembly is coupled to the bracket structure.

11. The imaging system of claim 10, wherein the first predetermined imaging-device angle corresponds to a first predetermined working distance and a first predetermined perspective for the imaging device, and
wherein the second predetermined imaging-device angle corresponds to a second predetermined working distance different from the first predetermined working distance and a second predetermined perspective different from the second predetermined working distance for the imaging device.

12. The imaging system of claim 1, wherein the imaging module is a first imaging module, the bracket structure is a first bracket structure, the mirror assembly is a first mirror assembly, and the guide plate is a first guide plate, and further comprising:
a second imaging module including:
a second bracket structure;
a second mirror assembly including a second mirror, the second mirror assembly being rotatably coupled to the second bracket structure and rotatably adjustable to a second plurality of mirror angles relative to the second bracket structure;
a second imaging assembly including a second imaging device, the second imaging assembly being rotatably coupled to the second bracket structure and rotatably adjustable to a second plurality of imaging-device angles relative to the bracket structure; and
a second guide plate that is configured to be coupled to the second bracket structure,
when the second guide plate is coupled to the second bracket structure, the second guide plate constrains the second mirror assembly to be oriented at a second predetermined mirror angle of the second plurality of mirror angles when the second mirror assembly is coupled to the second guide plate, and
when the second guide plate is coupled to the second bracket structure, the second guide plate constrains the second imaging assembly to be oriented at a second predetermined imaging-device angle of the second plurality of imaging-device angles when the imaging assembly is coupled to the second guide plate.

13. The imaging system of claim 12, wherein the first predetermined mirror angle and the second predetermined imaging-device angle collectively correspond to a first predetermined working distance and a first predetermined perspective for the second imaging device, and
wherein the second predetermined mirror angle and the first predetermined imaging-device angle collectively correspond to a second predetermined working distance and a second predetermined perspective for the first imaging device.

14. The imaging system of claim 13, wherein the first predetermined working distance is substantially the same as the second predetermined working distance, and
wherein the first predetermined perspective is substantially the same as the second predetermined perspective.

15. The imaging system of claim 12, wherein the first bracket structure and the second bracket structure are configured to be removably coupled to different locations along a longitudinal axis of the support frame, and
wherein the first guide plate corresponds to a first coupling location for the first bracket structure along the longitudinal axis of the support frame, and
wherein the second guide plate corresponds to a second coupling location, different from the first coupling location, for the second bracket structure along the longitudinal axis of the support frame.

16. The imaging system of claim 15, wherein the first guide plate and the second guide plate correspond to a predetermined distance that separates the first imaging module from the second imaging module along a longitudinal axis of the support frame.

17. The imaging system of claim 16, further comprising the support frame, the support frame including:
a first mechanical stop that is configured to contact the first bracket structure of the first imaging module; and
a second mechanical stop that is configured to contact the second bracket structure of the second imaging module, and
wherein the first mechanical stop and the second mechanical stop maintain the predetermined distance between the first imaging module and the second imaging module, based on one or more of a selected placement or length of the first and second mechanical stops.

18. The imaging system of claim 16, wherein the first bracket has a first flange that is configured to engage with the first mechanical stop, and wherein a third bracket of the second bracket structure includes a third flange that is configured to engage with the second mechanical stop, and
wherein the first flange extends in a first direction, and the third flange extends in a second direction opposite the first direction.

19. The imaging system of claim 12, wherein second mirror defines a first field of view (FOV) for the first imaging device, the first FOV being defined along a first optical path that extends from an object to the second mirror and to the first imaging device, after reflecting off the second mirror, and
wherein the first mirror defines a second FOV for the second imaging device, the second FOV being defined along a second optical path that extends from the object to the first mirror and to the second imaging device, after reflecting off the first mirror.

20. A method of installing an adjustable imaging arrangement, the method comprising:
placing a first imaging module into engagement with a support frame at a first location of the support frame, the first imaging module including a first angularly adjustable assembly constrained at a first predetermined angle according to a first guide plate; and
placing a second imaging module into engagement with the support frame at a second location of the support frame, the first imaging module including a second angularly adjustable assembly constrained at a second predetermined angle according to a second guide plate,
wherein a distance between the first location and the second location of the support frame is a predetermined distance corresponding to current angular orientations of the first and second angularly adjustable assemblies.
